(19) United States
(12) Patent Application Publication
(10) Pub. No.: US 2024/0254017 A1
(43) Pub. Date: Aug. 1, 2024

(54) REDOX-ACTIVE COMPOSITE AND ELECTROCHEMICAL REACTIVE SEPARATION OF NITRATE TO AMMONIA

(71) Applicant: The Board of Trustees of the University of Illinois, Urbana, IL (US)

(72) Inventors: Xiao SU, Champaign, IL (US); Kwiyong KIM, Champaign, IL (US)

(21) Appl. No.: 18/423,742

(22) Filed: Jan. 26, 2024

Related U.S. Application Data
(60) Provisional application No. 63/441,574, filed on Jan. 27, 2023.

(51) Int. Cl. C02F 1/461; C02F 1/467; C02F 101/16; C25B 1/27; C25B 11/052

(52) U.S. Cl. CPC C02F 1/46109; C02F 1/4676; C25B 1/27; C25B 11/052; C02F 2001/46142; C02F 2101/163; C02F 2303/16

(57) ABSTRACT

A redox-active composite comprises a conductive substrate including electrosorbent regions and electrocatalytic regions thereon, where the electrosorbent regions comprise a redox-active polymer and the electrocatalytic regions comprise a metal oxide. An electrochemical cell for electrochemical reactive separation of nitrate to ammonia includes a vessel configured for flow of a fluid therethrough, a bifunctional electrode comprising the redox-active composite positioned in the vessel, and a counter electrode spaced apart from the bifunctional electrode in the vessel.

### RELATED APPLICATION

The present patent document claims the benefit of priority under 35 U.S.C. 119(e) to U.S. Provisional Patent Application No. 63/441,574, which was filed on Jan. 27, 2023, and is hereby incorporated by reference in its entirety.

### TECHNICAL FIELD

The present disclosure is related generally to electrochemical processing, and more particularly to the electrochemical reactive separation of nitrate to ammonia.

### BACKGROUND

Nitrate, because of its mobility, water solubility, and persistence, has long been recognized as a widespread macropollutant that leads to eutrophication and algal blooms. Nitrate pollution from drinking water in the United States has been identified as a major cause of cancer, so a maximum contaminant level (MCL) of 11.3 and 10 mg/L NO₃—N is recommended by the World Health Organization (WHO) and US Environmental Protection Agency (EPA), respectively. Nitrate pollution is mainly caused by the overuse of reactive nitrogen-based fertilizers and nitrogen runoffs from agricultural use. Nitrogen loss by leaching and runoff is estimated to reach 132 Tg N yr⁻¹ in 2030, and the transport of nitrate from rivers to oceans accounts for 40-70 Tg N yr⁻¹. Several water purification methods have been proposed for the removal of nitrate, including ion exchange or reverse osmosis, but these methods can often be limited by high energy consumption, waste generation, and limitations in selectivity and capacity.

At the same time, nitrate can be a promising nitrogen source for ammonia production, in which a pollutant can be valorized into an energy carrier and fertilizer. In comparison with the triple N≡N bond in dinitrogen (941 kJ mol⁻¹), the N═O bond has a lower dissociation energy (204 kJ mol⁻¹), leading to faster ammonia production kinetics compared to dinitrogen. In this context, electrochemical conversion of nitrate to ammonia has been proposed as a decentralized and sustainable alternative to the energy- and carbon-intensive Haber-Bosch process, which contributes to 2% of the world's energy consumption, and 1-2% of the carbon dioxide emissions. Recent years have seen notable developments in enabling electrochemical nitrate reduction, but most of the electrochemical studies have used model or synthetic nitrate concentrations in a higher range (10-1000 mM) to evaluate the performance of catalysts and devices. However, in natural environments or even wastewater, nitrate concentrations are usually much more dilute, thus presenting significant transport barriers for (electro)catalytic performance irrespective of catalyst nature. While some point sources, such as nuclear waste, may contain relatively high levels of nitrate, the availability of nitrate-rich waste streams is limited, and such sources may contain interfering metal species, complicating the conversion step. In most cases, nitrate streams, such as those resulting from industrial or agricultural runoff or polluted groundwater, contain much lower concentrations of nitrate than being currently used in the electrochemical studies. Within the United States, typical nitrate levels in agricultural groundwater range between 0.2 and 0.4 mM, and about 80% of agricultural wells have nitrate concentrations less than the MCL of 10 mg/L NO₃—N (0.714 mM) set by EPA. Unfortunately, electrocatalysis can run into a significant extent of side reactions (e.g., hydrogen evolution), particularly under such low nitrate concentrations, which thus severely affecting the energy efficiency. Furthermore, the low ionic conductivity of dilute nitrate waste sources requires the integration of an additional separation step to remove and concentrate the nitrate before efficient electroconversion can occur. It would be beneficial to develop a method capable of overcoming these challenges.

### BRIEF DESCRIPTION OF THE DRAWINGS

FIG. 1A is a schematic of a process for nitrate capture and conversion to ammonia which is enabled by the bifunctional electrode described in this disclosure.

FIG. 1B is a cross-sectional schematic of the bifunctional electrode that enables the capture and conversion illustrated in FIG. 1A.

FIGS. 2A-2C are cross-sectional schematics illustrating an electrochemical cell and method for electrochemical reactive separation of nitrate to ammonia that includes the bifunctional electrode of FIG. 1B.

FIGS. 3A-3C show illustrate the capture, release and conversion carried out by the bifunctional electrode upon anodic (+0.4 V vs Ag/AgCl) and cathodic (−0.5 V vs Ag/AgCl; −1.4 V vs Ag/AgCl) charging.

FIG. 4 provides a schematic illustration of a fabrication process of an exemplary bifunctional electrode.

FIG. 5 shows a scanning electron microscopy (SEM) image of a bifunctional electrode comprising PANI-Co₃O₄/CNT.

FIG. 6A shows a cyclic voltammogram of a PANI/CNT electrode in 0.5 M H₂SO₄; scan rate was 5 mV s⁻¹.

FIG. 6B illustrates redox-interconversion of PANI caused by a change in electrode potential and solution pH, where LS is leucoemeraldine salt, LB is leucoemeraldine base, ES is emeraldine salt, EB is emeraldine base, PS is pernigraniline salt, PB is pernigraniline base.

FIG. 6C shows a heatmap of nitrate uptake capacity (mg NO₃⁻ g⁻¹ PANI) at various pH levels and electrode potentials; both NO₃⁻ and Cl⁻ concentrations were 5 mM.

FIG. 6D shows a heatmap of separation factor (SF) of PANI toward nitrate over chloride at various pH levels and electrode potentials; both NO₃⁻ and Cl⁻ concentrations were 5 mM.

FIG. 7A shows atomic Bader charges of NO₃⁻/Cl⁻ species bonded to the PANI, where the total Bader charge was calculated on the optimized adsorbates-PANI structures, and the average values of NO₃⁻ and Cl⁻ are presented.

FIG. 7B shows separation factors toward nitrate over chloride and difference in binding energies (BEs) for nitrate and chloride to four different PANI species.

FIG. 8A illustrates nitrate uptake capacity using PANI/CNT and PANI-Co₃O₄/CNT composites at various Co₃O₄ loadings.

FIG. 8B shows the percentage of nitrogen species recovered in the form of nitrate, nitrite, and ammonium after release into 0.1 M NaCl for 1 h at various electrode potentials; before release, electrosorption was carried out in 5 mM NaNO₃+5 mM NaCl at +0.4 V vs Ag/AgCl for 0.5 h.

FIG. 8C shows nitrate uptake capacity (left y axis) and percentage of nitrogen species recovered (right y axis) after one full cycle of electrosorption and regeneration using CNT, PANI/CNT, and PANI-Co₃O₄/CNT electrodes, where electrosorption was carried out in 5 mM NaNO₃+5 mM NaCl at +0.4 V vs Ag/AgCl for 0.5 h, and regeneration was performed in 0.1 M NaCl at −1.4 V vs Ag/AgCl for 1 h.

FIG. 8D shows ¹H-NMR spectra for the regeneration electrolytes after a full cycle of electrosorption (+0.4 V vs Ag/AgCl) and release (−1.4 V vs Ag/AgCl).

FIG. 9A is a schematic illustration of two scenarios for treating a dilute nitrate stream (corn/soy tile drainage sample collected from the University of Illinois Energy Farm), where in scenario A, an electrocatalyst directly electrocatalyzes the dilute nitrate feed, and in scenario B, to overcome the low nitrate concentration and conductivity, a full cycle of adsorption and regeneration is performed to generate an up-concentrated, localized nitrate stream, which then can be electrocatalyzed by the same electrode in one device, solely by controlling electrode potential.

FIG. 9B shows regeneration efficiency (nitrate recovered/nitrate adsorbed) measured after release at −0.5 V vs Ag/AgCl into 0.1 M NaCl containing various initial nitrate concentrations; before release, adsorption was carried out in 5 mM NaNO₃+5 mM NaCl at +0.4 V vs Ag/AgCl for 0.5 h.

FIG. 9C shows nitrate concentration of the diluted tile drainage feed and the receiving solution before and after a full cycle of adsorption (in 20 mL) and desorption (in 1 mL) in the scenario B.

FIG. 9D shows Faradaic efficiency and ammonia yield rate of PANI-Co₃O₄/CNT electrodes in the scenarios A and B.

FIG. 9E shows a comparison of the energy consumption (kWh kg⁻¹-N) in the scenarios A and B.

FIG. 10 shows starting nitrate concentrations and corresponding energy consumptions (kWh kg⁻¹-N) for this study in comparison with other investigations.

### DETAILED DESCRIPTION

Described herein are bifunctional electrodes that couple a nitrate-selective redox-electrosorbent such as polyaniline with an electrocatalyst such as cobalt oxide for nitrate to ammonium conversion within a single electrochemical cell. An all-electrified approach for the synergistic coupling of dilute nitrate capture, up-concentration and conversion to ammonia has been developed to enhance the energy efficiency and reduce the capital cost of valorizing dilute nitrate streams. The synergistic reactive separation of nitrate solely through electrochemical control is demonstrated in this disclosure. Electrochemically-reversible nitrate uptake greater than 70 mg/g can be achieved, with electronic structure calculations and spectroscopic measurements providing insight into the underlying role of hydrogen bonding for nitrate selectivity. Using agricultural tile drainage water containing dilute nitrate (0.27 mM), it is shown that the bifunctional electrode may achieve an 8-fold up-concentration of nitrate, a 24-fold enhancement of ammonium production rate (108.1 μg h⁻¹ cm⁻²), and a >10-fold enhancement in energy efficiency when compared to direct electrocatalysis in the dilute stream. Accordingly, mass transport limitations due to the dilute concentration of nitrate in water streams, which are a key obstacle to the efficient conversion of nitrate to ammonia, can be overcome. This methodology provides a generalized strategy for a fully electrified reaction-separation pathway for modular nitrate remediation and ammonia production.

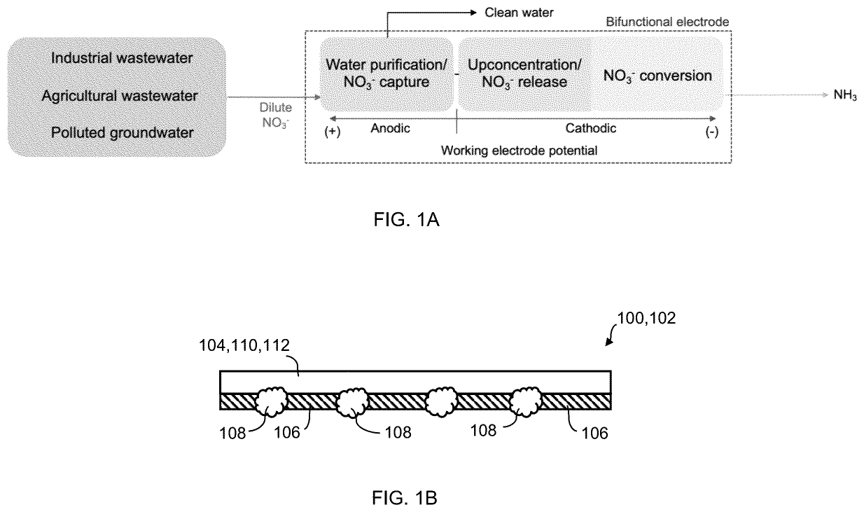

The bifunctional electrode 100 for electrochemical reactive separation of nitrate to ammonia may comprise a redox-active composite 102, as shown schematically in the cross-sectional view of FIG. 1. The redox-active composite 102 comprises a conductive substrate 104 including electrosorbent regions 106 and electrocatalytic regions 108 thereon, wherein the electrosorbent regions 106 comprise a redox-active polymer, and wherein the electrocatalytic regions 108 comprise a metal oxide. As illustrated, the electrosorbent regions 106 are spatially distinct from the electrocatalytic regions 108. The redox-active polymer may be understood to be a polymer that includes redox-active units that can undergo an electron transfer process to become oxidized or reduced.

In some examples, the redox-active polymer may comprise polyaniline and/or polypyrrole. The redox-active polymer may be configured for ion-exchange or hydrogen bonding with nitrate. The redox-active polymer may include an amine functional group. A mass loading of the redox-active polymer on the conductive substrate 104 may be in a range from about 1 mg to about 5 mg. In some examples, the metal oxide comprises cobalt oxide (e.g., Co₃O₄). The metal oxide functions as an electrocatalyst for conversion of nitrate to ammonia. The metal oxide is advantageously stable under anodic and cathodic polarization and/or in both acidic and alkaline solutions. A mass loading of the metal oxide on the conductive substrate 104 may be in a range from about 0.3 mg to about 5 mg.

The conductive substrate 104 may comprise a metal support 110 which in some examples may be coated with a carbon-based material 112, such as carbon nanotubes, activated carbon, carbon cloth, and/or an aerogel. An average loading level of the carbon-based material on the metal support may be in a range from about 0.5 mg cm⁻² to about 4 mg cm⁻². The metal support 110 may comprise a metal mesh, such as a titanium mesh.

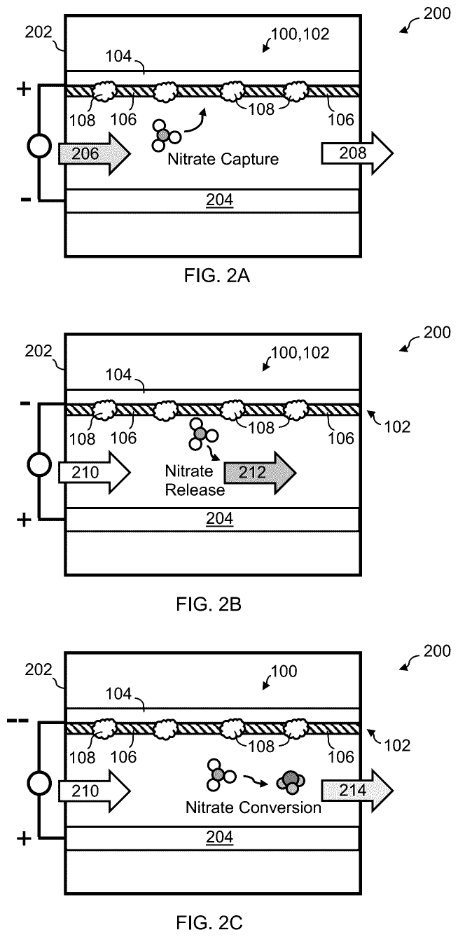

FIGS. 2A-2C are schematics of an electrochemical cell 200 for electrochemical reactive separation of nitrate to ammonia that includes the bifunctional electrode 100 and redox-active composite 102 described above. Referring to FIG. 2A, the electrochemical cell 200 includes a vessel 202 configured for flow of a fluid therethrough, and a bifunctional electrode 100 positioned in the vessel 202, where the bifunctional electrode comprises a conductive substrate 104 including electrosorbent regions 106 and electrocatalytic regions 108 thereon. As discussed above, the electrosorbent regions 106 comprise a redox-active polymer, and the electrocatalytic regions 108 comprise a metal oxide. Also contained in the vessel 202 is a counter electrode 204 spaced apart from the bifunctional electrode 100. The conductive substrate 104, the redox-active polymer, and/or the metal oxide have any or all of the characteristics described in this disclosure.

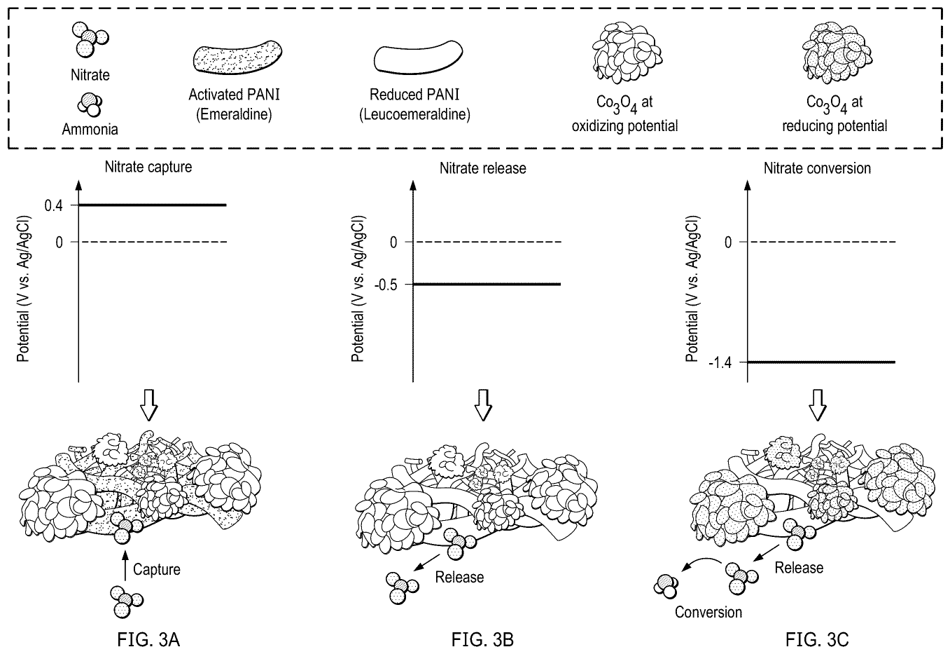

An electrochemical method for nitrate remediation and ammonium production is now described, in reference to FIGS. 2A-2C and FIGS. 3A-3C. The electrochemical method comprises providing an electrochemical cell 200 including a working electrode (bifunctional electrode) 100, which, as described above, comprises a conductive substrate 104 having electrosorbent regions 106 and electrocatalytic regions 108 thereon. In the examples below, polyaniline or PANI (the redox-active polymer) is combined with cobalt oxide or Co₃O₄ (the metal oxide electrocatalyst) supported on carbon nanotubes (CNT; the carbon-based material) to serve as the bifunctional electrode, although other redox-active polymers, metal oxides, and carbon-based materials may be used. The bifunctional electrode 100 may enable the integration of separation, regeneration/up-concentration, and electrocatalysis in a single electrochemical device under isothermal conditions, without the need to separately generate and transport concentrated nitrate, and equally importantly, with no use of chemical regeneration during the separation step.

Referring to FIG. 2A, an anodic potential is applied to the working electrode 100 and a waste fluid 206 is flowed into the electrochemical cell 200. The waste fluid 206 may be obtained from industrial runoff, agricultural runoff, polluted groundwater, or another source. Nitrate from the waste fluid 206 is selectively adsorbed onto the electrosorbent regions 106, and a purified water stream 208 is formed. As discussed in the examples below, electrosorbent regions 106 comprising polyaniline (PANI) as the redox-active polymer can selectively capture nitrate via ion-exchange and hydrogen bonding in a synergistic manner. Upon anodic charging (e.g., at +0.4 V vs Ag/AgCl), PANI is activated to emeraldine, which serves as an electrosorbent for nitrate, as illustrated in FIG. 3A. Notably, the waste fluid 206 may include a dilute concentration of the nitrate. For example, the dilute concentration may be less than 10 mM, or less than 1 mM, and/or as low as 0.01 mM, or as low as 0.1 mM. The purified water stream 208 is then removed from the electrochemical cell 200.

Referring now to FIG. 2B, a first cathodic potential is applied to the working electrode 100 and a receiving fluid 210 is flowed into the electrochemical cell 200. Consequently, the nitrate is released from the electrosorbent regions 106 into the receiving fluid 210 and a concentrated receiving solution 212 is formed. During cathodic charging (e.g., −0.5 V vs Ag/AgCl), PANI is reduced to leucoemeraldine, and the adsorbed nitrate is released, as illustrated in FIG. 3B. In the examples below, a mechanistic investigation to elucidate the structural influence of different PANI species (leucoemeraldine, emeraldine, and pernigranline) on nitrate selectivity is discussed.

Referring now to FIG. 2C, a second cathodic potential is applied to the working electrode 100, where the second cathodic potential is more negative than the first cathodic potential, and thus the nitrate from the concentrated receiving solution 212 (shown in FIG. 2B) is electrocatalyzed to ammonium or ammonia (shown in FIG. 2C). Simultaneously, the electrosorbent regions 106 on the conductive substrate 104 are regenerated. Electrocatalysis is effected by the metal oxide, e.g., Co₃O₄, of the bifunctional electrode 100. In the examples below, Co₃O₄ is selected as a model nitrate-reducing metal oxide based on its electrocatalytic activity and durability under various pH-potential conditions. Also, the synthesis method discussed below exploits the intrinsically low electrical conductivity of Co₃O₄ to spatially control the electropolymerization of PANI on conductive CNT, without covering the catalytic surface of Co₃O₄. During the second cathodic charging (e.g., −1.4 V vs Ag/AgCl), PANI regeneration may be coupled with nitrate electroconversion to ammonia by Co₃O₄, as illustrated in FIG. 3C. Exposure of both PANI and Co₃O₄ to the receiving fluid 210 (electrolyte) are found not to negatively impact separation (by PANI) and reaction (by Co₃O₄).

The concentration of the nitrate in the concentrated receiving solution 212 is at least 8 times the dilute concentration of the nitrate in the waste fluid 206. The electrocatalyzed receiving solution 214 (or the concentrated receiving solution 212 if nitrate electroconversion is not carried out) may be removed from the electrochemical cell 200. The electrochemical process may be carried out under isothermal conditions, without the need to separately generate and transport concentrated nitrate, and/or with no use of chemical regeneration during the separation (release) step.

When the bound nitrate is electrochemically released as described above, the bifunctional electrodes generate a localized nitrate-rich receiving stream with suitable conductivity for electroreduction, thus enabling electrocatalytic conversion of nitrate to ammonium (half-cell reaction: NO₃⁻+6H₂O+8e⁻→NH₃+90H⁻) with low energy consumption and enhanced faradaic efficiency. An ammonia yield rate of the bifunctional electrode 100 may be at least about 100 μg h⁻¹ cm⁻². The electrochemical method may be carried out with a total energy consumption of less than 300 kWh kg⁻¹-N, or less than 250 kWh kg⁻¹-N. Also or alternatively, a faradaic efficiency of the working electrode (bifunctional electrode) may be at least about 25%. Furthermore, the electrosorbent regeneration can be coupled directly with nitrate reduction solely by controlling release potential, as discussed above, enabling process intensification in a modular fashion.

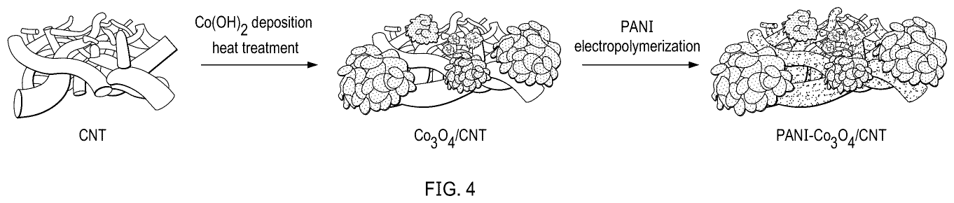

Also described is a method of making the above-described redox-active composite and bifunctional electrode. The method includes electrodepositing a metal hydroxide on a conductive substrate, where the metal hydroxide accumulates during electrodeposition to form clusters. In the example shown in FIG. 4, the metal hydroxide is Co(OH)₂ and the conductive structure includes carbon nanotubes (CNT). After the electrodeposition, the clusters are heat treated to transform the metal hydroxide into a metal oxide, thereby forming electrocatalytic regions comprising the metal oxide on the conductive substrate. In the example shown in FIG. 4, the Co(OH)₂ is transformed into Co₃O₄. After the heat treatment, a redox-active polymer (PANI in the example of FIG. 4) is electropolymerized on the conductive substrate. The electropolymerization occurs in regions between the electrocatalytic regions, and electrosorbent regions comprising the redox-active polymer are formed on the conductive substrate. As illustrated in FIG. 4, the electrosorbent regions are spatially distinct from the electrocatalytic regions.

The method may further include, prior to electrodepositing the metal hydroxide, forming the conductive substrate, which comprises a metal support that may be coated with a carbon-based material. To form the conductive substrate, a slurry comprising the carbon-based material is applied to the metal support. Application of the slurry may entail dip coating, spin coating, or another solution coating method. The carbon-based material may comprise carbon nanotubes, activated carbon, carbon cloth, and/or an aerogel. An average loading level of the carbon-based material on the metal support is in a range from about 1 mg cm⁻² to about 2 mg cm⁻².

Electrodepositing the metal hydroxide may comprise submerging the conductive substrate in an electrolyte comprising a metal nitrate, and applying a fixed potential to the conductive substrate. The metal nitrate may comprise cobalt nitrate, the metal hydroxide may comprise cobalt hydroxide, and the metal oxide may comprise cobalt oxide. The electrolyte may comprise 0.1 M Co(NO₃)₂·6H₂O, and/or the fixed potential may be about −1.0 V vs Ag/AgCl. The electrodeposition may take place for a time duration in a range from 1 minute to about 10 minutes.

The heat treating of the clusters may take place at a temperature in a range from 100° C. to 400° C. and/or at a heating rate in a range from 1° C./min to 10° C./min. The heat treatment may be carried out for a time duration in a range from 10 min to 120 min.

Electropolymerization of the redox-active polymer may entail submerging the conductive substrate in an electrolyte comprising a monomer solution under galvanostatic conditions. In one example, the monomer solution may comprise 0.2 aniline+0.5 M H₂SO₄, and the redox-active polymer may be polyaniline.

The method may further include, after the electrodeposition and/or the electropolymerization, rinsing the conductive substrate with water, and then drying.

### Examples

The examples below show how the bifunctional electrodes described above can achieve process intensification for nitrogen valorization. By combining electro-driven separation with electrocatalysis, process intensification is enabled through solely electrochemical pathways, paving the way for a fully decentralized, renewable-driven nitrate remediation and ammonium production system.

### Characterization of Bifunctional Electrodes

A bifunctional electrode comprising PANI-Co₃O₄/CNT was synthesized by first electrodepositing Co(OH)₂ on a conductive substrate comprising CNT, followed by heat treatment and subsequent PANI electropolymerization, as illustrated in FIG. 4. X-ray diffraction (XRD) analysis confirmed that Co(OH)₂ was obtained by electrodeposition in 0.1 M Co(NO₃)₂ at −1.0 V vs Ag/AgCl, which was then converted to Co₃O₄ by heat treatment. Even after anodic electropolymerization of PANI under acidic conditions, the XRD pattern of PANI-Co₃O₄/CNTs was not changed, indicating that the crystal structure of Co₃O₄ was maintained during the coating of PANI.

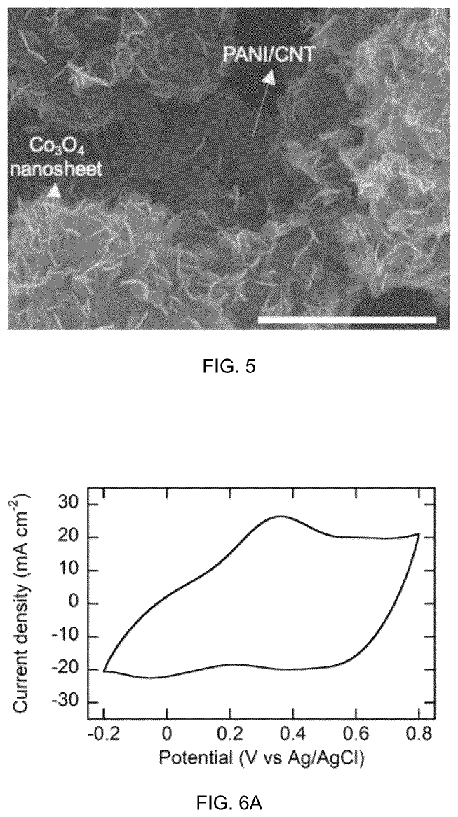

Transmission electron microscopy (TEM) and scanning electron microscopy (SEM) were used to investigate the morphology of PANI/CNT and PANI-Co₃O₄/CNT composites. For PANI/CNT, a thin amorphous PANI layer was formed onto cylindrical CNT during the electropolymerization. The TEM and SEM images of PANI-Co₃O₄/CNT showed that the composite was constructed from distinct domains of Co₃O₄ nanosheets, which were spatially separated from one another (FIG. 5). As Co(OH)₂ is electrodeposited, the existing particles may serve as active spots on which successive deposition takes place preferentially, thus resulting in locally grown clusters of nanosheets. On the other hand, because PANI electropolymerizes only on conductive surfaces and Co₃O₄ is not electrically conductive, PANI was not coated on Co₃O₄ but rather on adjacent CNT.

Energy-dispersive x-ray spectroscopy (EDS) analysis confirmed that PANI-Co₃O₄/CNT composites contained both PANI/CNT layers and Co₃O₄ with nanosheets morphology in distinct domains. According to the electron energy loss spectroscopy (EELS) analysis, a clear nitrogen peak at 402 eV appeared on the surface of the PANI/CNT in the PANI-Co₃O₄/CNT, which was not detectable on the surface of the Co₃O₄ nanosheet. With clear accessibility to the electrolyte solution, the bifunctional electrode facilitates their dual function as an electrosorbent and electrocatalyst. High-resolution TEM (HRTEM) analysis confirmed that the nanosheets are comprised of Co₃O₄ nanoparticles.

### Selective Electrosorption of Nitrate by Bifunctional Electrodes

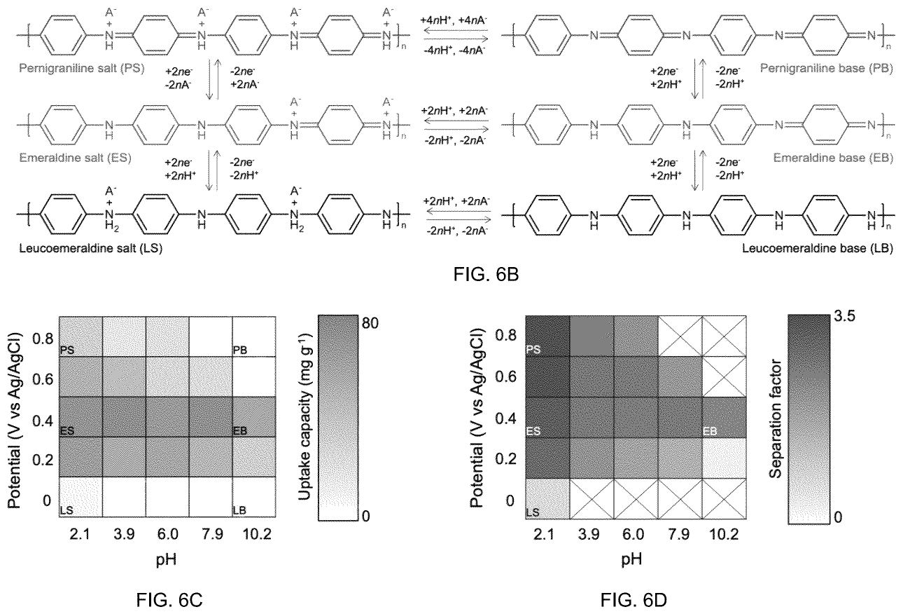

FIG. 6B shows the redox-interconversion of PANI with different oxidation states (leucoemeraldine, emeraldine, and pernigraniline) and their respective protonation. As shown in a cyclic voltammogram (CV) of PANI/CNT in 0.5 M H₂SO₄ (FIG. 6A), the first major anodic peak at +0.3V vs Ag/AgCl can be attributed to the oxidation of leucoemeraldine to emeraldine, and another oxidation onset at about +0.73 V vs Ag/AgCl can be assigned to the oxidation of emeraldine to pernigraniline. Depending on the pH of the solution, each oxidation state can be protonated into “salt” or deprotonated into “base”, thus generating six different forms (LS, LB, ES, EB, PS, and PB) (FIG. 6B) of PANI.

The affinity of six different forms of PANI to nitrate was examined by using PANI/CNT as heterogeneous electrosorbents, in solutions containing 5 mM NO₃⁻ and equimolar Cl⁻ as a competing species. By varying pH and electrochemical potential for electrosorption, a heatmap, shown in FIG. 6C, was constructed for nitrate uptake (mg NO₃⁻ g⁻¹ PANI). Regardless of pH, nitrate uptake was negligible at 0 V vs Ag/AgCl, since reducing PANI to leucoemeraldine generated negative current, and the resulting electrostatic repulsion impedes the electrostatic approach of nitrate to the working electrode. In order to obtain a better understanding of the heatmap, the point of zero charge (PZC) of PANI/CNTs with different oxidation states was determined by using a pH drift method. The observed PZCs of PANI films polarized at +0.4 and +0.8 V vs Ag/AgCl (as a representative of emeraldine and pernigraniline, respectively) were 4.20 and 3.60, respectively. PZC analysis indicated that pernigraniline PANI (+0.8 V vs Ag/AgCl) carried a positive charge only at pH<3.60, possibly from protonated quinoid imine groups (—NH⁺═), which may act as an ion-exchange site for nitrate uptake (FIG. 6B). As equilibrium pH increased, deprotonation occurred during the conversion of —NH⁺═ to —N═, resulting in the loss of ion-exchange sites. Compared to pernigraniline, emeraldine has a slightly broader pH window where PANI exists in protonated salt. Interestingly, at a higher pH range (>7), nitrate binding still occurred on emeraldine at +0.4 V vs Ag/AgCl (FIG. 6C). At these pH and potential levels, PANI was expected to exist primarily as EB, which does not possess a positively charged —NH⁺═ groups. The uptake is therefore attributed to hydrogen bonding via benzoid amine (—NH—) in EB. Conversely, at high pH (>7), pernigraniline (+0.8V vs Ag/AgCl) has only quinoid imines (—N═), which does not contain hydrogen bond sites, so nitrate adsorption did not take place at high pH and high oxidation potentials (FIG. 6C)—as may be elucidated below by DFT calculations. The ES form, especially at +0.4 V vs Ag/AgCl, provided the best capacity for nitrate uptake (>70 mg NO₃⁻¹ g⁻¹ PANI) through synergistic ion-exchange and hydrogen bonding. X-ray photoelectron spectroscopy (XPS) survey scan showed a signal for S2p in a pristine PANI/CNT, which indicates the presence of sulfate (SO₄²⁻) as a counter ion doped during the PANI electropolymerization step in sulfuric acid. Compared to the pristine electrode (N:S:Cl=75.6:24.4:0), PANI/CNT after electrosorption exhibited a decreased atomic ratio of sulfur (N:S:Cl=85.1:4.7:10.2), yet an increase in nitrogen and chloride, demonstrating that ion-exchange occurred. Attenuated total reflection infrared (ATR-IR) spectroscopy analysis revealed that emeraldine PANI treated in 1 M NaOH for 24 h—regarded as EB-exhibited a shoulder of N—H stretch at 3388 cm⁻¹, which is a characteristic of the free (not hydrogen-bonded) N—H groups when PANI is in its undoped state. Due to intermolecular hydrogen bonding, EB also exhibits a peak of hydrogen-bonded N—H groups at about 3300 cm⁻¹. On the other hand, in emeraldine PANI treated in 1 M NaNO₃ for 24 h, there was shift to lower wavenumber (3225 cm⁻¹), which corresponds to the stretching vibration of the secondary amine N—H group hydrogen bonded with nitrate, in alignment with the previous observations from the literature on H-bonding.

A heatmap was constructed also for separation factors (SFs) obtained using PANI/CNT at various combinations of pH and potential to see the structural dependence of selectivity between nitrate and chloride (FIG. 6D). Some combinations which resulted in negligible uptake (<5 mg g⁻¹) were excluded. In general, lower pH resulted in higher SF toward nitrate compared to chloride, reaching a SF of 3.45 at PS (0.8 V vs Ag/AgCl, pH=2.1). In terms of oxidation state, the more oxidized salt (higher potential) exhibited better selectivity toward nitrate, and LS exhibited higher affinity toward chloride (SF: 0.79 at 0 V vs Ag/AgCl, pH=2.1) (FIG. 6D).

### Mechanistic Study for Nitrate Affinity and Selectivity on Bifunctional Electrodes

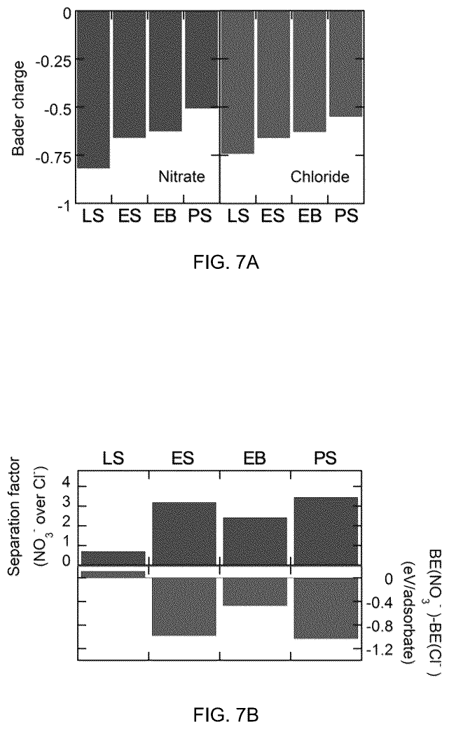

To elucidate the affinity and selectivity of the electrosorption of nitrate on PANI, density functional theory (DFT) calculations and structure optimization based on classical force fields were carried out to investigate the underlying binding mechanism. Theoretical calculations and experimental results were correlated by selecting six representative PANI-nitrate binding configurations based on the pH-potential heatmap (FIGS. 6C and 6D). First, the DFT binding energy (BE) was lower (thus more stable) for more reduced salts than for more oxidized salts (e.g., −4.44, −1.88, and −1.41 eV/adsorbate for [LS-nitrate], [ES-nitrate], and [PS-nitrate], respectively). The trend in BEs for PANI salts is in accordance with the uptake capacity (e.g., 5.2, 71.1, and 30.7 mg NO₃⁻ g-1 PANI, for LS, ES, and PS, respectively), except for LS, where electrostatic repulsion from negative current dominated. Bader charge analysis revealed that nitrate and chloride anion bound to the more reduced PANI species exhibited a more negative charge, indicating stronger interaction with hydrogen bound to nitrogen in PANI (FIG. 7A).

The BEs of [PANI-nitrate] and [PANI-chloride] were also compared and correlated with the trend in SF determined experimentally. The BE of [LS-chloride]was 0.11 eV/adsorbate smaller than [LS-nitrate], implying higher stability of [LS-chloride] complex (FIG. 7B). The experimental SF (toward nitrate over chloride) was 0.70, indicating that chloride is more selective and agreeing with DFT calculation (FIG. 7B). On the other hand, ES, EB, PS exhibited lower BE for nitrate compared chloride, and PS exhibited the largest difference between BEs of [PANI-nitrate] and [PANI-chloride], followed by ES and EB. Interestingly, the trend in SFs of four different species—PS (SF: 3.45)>ES (SF: 3.19)>EB (SF: 2.42)>LS (SF: 0.70)—is in agreement with the prediction from the difference in BEs between nitrate and chloride. After looking more closely, the adsorption of nitrate was characterized by a shorter distance between nitrate and PANI than the distance between chloride and PANI for all PANI species analyzed. Also, structure optimization based on classical force fields revealed the repulsive interaction between adsorbates and PB, resulting in a distance larger than 8 Å from PANI, confirming experimental observations that PB does not significantly bind nitrate. On the other hand, in ES, hydrogen bonding between NO₃⁻ and benzoid amine (—NH—) occurs, with the distance between nitrate and PANI being 1.74 and 1.80 Å. It was found that nitrate-PANI interactions increase the —NH— bonds by 0.03-0.06 Å compared to the pristine PANI structures, with the most pronounced effect on LS, providing evidence of electrochemically-activated hydrogen bonding. The spectroscopic observations, electrosorption results, and DFT investigation support the selective nature of PANI electrosorbents toward nitrate, with the mechanism being a synergistic combination of electrostatics and hydrogen bonding.

Reversible Electrochemical Release of Nitrate and Coupled Electroconversion into Ammonia

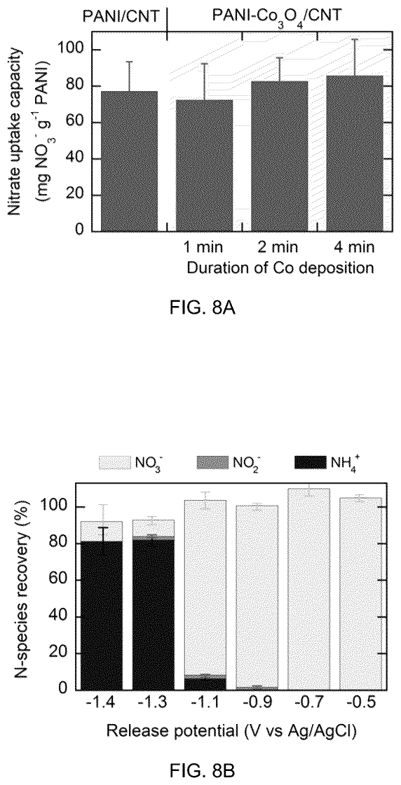

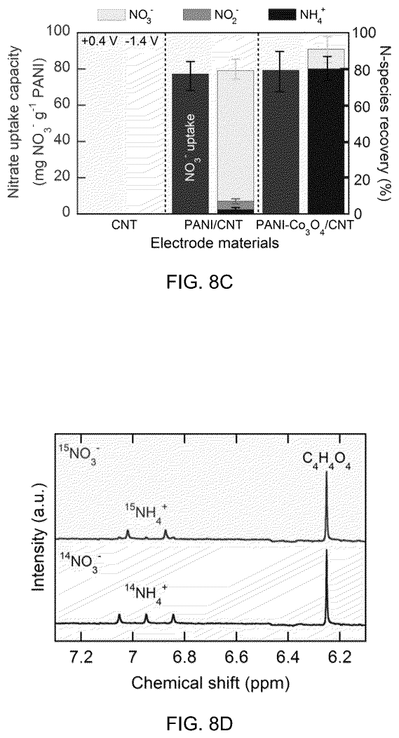

Preliminary tests with CO₃O₄/CNT electrodes demonstrated catalytic activity at a potential below −1.0 V vs Ag/AgCl, with a reasonable ammonia yield rate (566 ug h⁻¹ cm⁻²), high faradaic efficiency (87.7%), and high product selectivity (86.8%) at −1.4 V vs Ag/AgCl. Co₃O₄ has been found to be stable in acidic media and under oxidizing conditions, with these stability properties being highly desirable given the swing to anodic potentials during electrochemical nitrate capture in this work. Whether the presence of Co₃O₄ interfered with nitrate adsorption in the PANI-Co₃O₄/CNT system was tested. Co₃O₄ loading was controlled by varying the duration of Co(OH)₂ deposition (1, 2, and 4 min). Next, PANI was electropolymerized at a constant current (3 mA cm⁻²) in 0.2 M aniline+0.5 M H₂SO₄ for 5 min to achieve a constant loading of PANI. It was found that the original redox-behavior of PANI was preserved regardless of Co₃O₄ loading. Likewise, the presence of clusters of Co₃O₄ nanosheets did not influence nitrate uptake capacity, indicating the absence of any noticeable steric inhibition (FIG. 8A). Thus, PANI-Co₃O₄/CNTs with Co(OH)₂ deposition for 4 min were used for further experiments.

The effect of release potential on the final speciation of nitrogen into a desorption electrolyte was investigated. Electrosorption of nitrate was carried out with PANI-Co₃O₄/CNT at +0.4V vs Ag/AgCl in 5 mM NaNO₃+5 mM NaCl, and discharged at various release potentials into a clean electrolyte solution (0.1 M NaCl). FIG. 8B shows that close to 100% nitrate recovery was obtained at moderate potentials, including −0.5 and −0.7 V vs Ag/AgCl, demonstrating reversible PANI regeneration. Reduced species, like nitrite and ammonium, started to appear after release at −0.9 V vs Ag/AgCl, and at −1.4 V vs Ag/AgCl>80% of nitrogen was recovered as ammonium (FIG. 8B). As the electrode potential changed from −1.1 to −1.3V vs Ag/AgCl, ammonia production stepped up, suggesting that at −1.1 V vs Ag/AgCl, activation polarization dominated and mass transport was the limiting factor at −1.3 V vs Ag/AgCl. As a control, CNT did not show any uptake of nitrate, with no nitrogen species recovered or released (FIG. 8C). PANI/CNT without Co₃O₄ also showed similar electrosorption performance as PANI-Co₃O₄/CNT, but after release at −1.4 V vs Ag/AgCl exhibited <10% conversion to ammonium, due to the absence of catalytically active sites (FIG. 8C). Thus, both Co₃O₄ and the PANI/CNT are important for the separation and reaction of nitrate to ammonium in an electro-swing fashion. PANI-Co₃O₄/CNT prepared by physically mixing each component exhibited poorer nitrate uptake (<35 mg g⁻¹) and nitrate-to-ammonia conversion (<55%), because the agglomeration of each component hindered efficient mass transport.

In addition, cycling tests were conducted with the PANI-Co₃O₄/CNT electrodes being charged at +0.4 V vs Ag/AgCl for electrosorption, in the presence of 5 mM NaNO₃+5 mM NaCl for 0.5 h, and then discharged at −0.5 or −1.4 V vs Ag/AgCl 1 h into 0.1 M NaCl. Despite the decrease in uptake capacity after the first cycle, the working capacity of PANI-Co₃O₄/CNT was stabilized at 40 mg NO₃⁻¹ g⁻¹ PANI over four cycles. When discharged at −0.5 V vs Ag/AgCl, nitrate was the final speciation with >75% recovery for all the four cycles. When released at −1.4 V vs Ag/AgCl, the conversion efficiency into ammonium declined slightly, but still maintained at >65% after the 4th cycle. No significant cobalt leaching was observed in an inductively coupled plasma assay in the adsorption/release electrolyte. Further, high-resolution XPS analysis revealed that there was no substantial change in Co³⁺/Co²⁺ ratio after single anodic (+0.4 V vs Ag/AgCl) and cathodic (−1.4 V vs Ag/AgCl) charging and after four repeated cycles, indicating stable state of valence of cobalt oxide.

Finally, isotope-labeling tests through electrosorption at +0.4 V vs Ag/AgCl in the presence of ¹⁴NO₃⁻ or ¹⁵NO₃⁻ were performed, followed by release at −1.4 V vs Ag/AgCl in 0.1 M NaCl. ¹H-NMR spectra of desorption electrolytes (FIG. 8D) revealed that, after release, ¹⁵NO₃⁻-adsorbing PANI-Co₃O₄/CNT led to a doublet (¹⁵N-¹H coupling) while ¹⁴NO₃⁻-adsorbing PANI-Co₃O₄/CNT produced a triplet (¹⁴N-¹H coupling), thereby verifying the origin of ammonia from adsorbed nitrate. In addition, the isotope-labeled quantification was consistent with the colorimetric NH₃ assay utilizing indophenol blue.

Integration of Separation, Up-Concentration, and Nitrate-to-Ammonia Conversion from Nitrate-Impacted Agricultural Streams

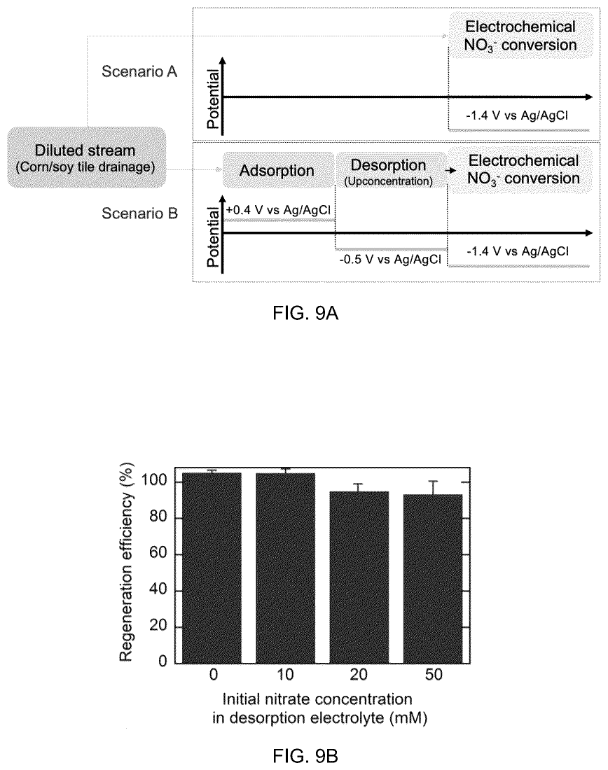

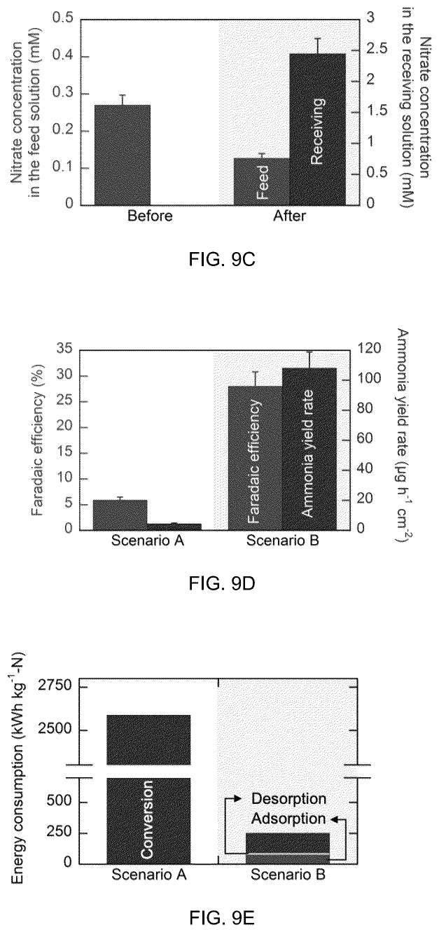

The key challenge of most major nitrate sources (e.g., agricultural groundwater and runoff) is their low concentrations and conductivity, and the presence of natural interfering species. Thus, to understand the role combined effect of nitrate concentration and conductivity on reactive separation and conversion to ammonia in practical water streams, we established two application scenarios (FIG. 9A), and applied them for reactive separations of nitrate from corn/soy tile drainage collected from University of Illinois Energy Farm, in which nitrate concentration and conductivity were 0.27 mM and 505 μS/cm, respectively. For scenario A, direct electrochemical reduction of nitrate was carried out in a diluted stream (20 mL of tile drainage). For scenario B, we performed a full cycle of electrosorption (+0.4 V vs Ag/AgCl) and release (−0.5 V vs Ag/AgCl) for nitrate capture and up-concentration, respectively; for the electrosorption, 20 mL of the tile drainage was used, and for desorption, smaller receiving volume (1 mL) of 0.1 M NaCl was used for nitrate up-concentration.

In a preliminary experiment, the composite electrodes released >93% of adsorbed nitrate into a pre-concentrated synthetic nitrate stream (50 mM) (FIG. 9B), proving the feasibility of electrochemical up-concentration. FIG. 9C shows the capability of PANI-Co₃O₄/CNT transferring nitrate from the tile drainage to the receiving solution, generating a final nitrate concentration of 2.45 mM after a full elctrosorption/desorption cycle (+0.4/−0.5 V vs Ag/AgCl). At the same time, the concentration of nitrate in the feed was reduced to 0.13 mM. The full cycle of electrosorption/regeneration demonstrates the coupling of water remediation, and the generation of localized nitrate streams with the required conductivity for efficient electrocatalytic conversion to ammonia.

Afterward, the up-concentrated nitrate was electrocatalyzed to ammonium by further reducing the potential down to −1.4V vs Ag/AgCl (FIG. 9A), within the same electrochemical device. The increased nitrate concentration and conductivity in the concentrated receiving solution provided an enhanced electrochemical environment with increased mass transfer, so scenario B exhibited a remarkable enhancement in faradaic efficiency (28%) and ammonia production rate (108.1 ug h⁻¹ cm⁻²) compared to directly electrocatalyzing the tile drainage, which exhibited much poorer Faradaic efficiency (5.9%) and ammonia production rate (4.5 ug h⁻¹ cm⁻²) (scenario A) (FIG. 9D) due to mass transfer limitations and ionic resistance. Even when the time required for adsorption and desorption were all considered for the determination of ammonia production rate, the revised production rate in scenario B (46.1 ug h⁻¹ cm⁻²) was still an order-of-magnitude greater than scenario A. Furthermore, an energy analysis revealed that for scenario B, the total energy consumption (251.3 kWh kg⁻¹-N) including adsorption (18.2 kWh kg⁻¹-N), desorption (74.0 kWh kg⁻¹-N), and catalysis (159.1 kWh kg⁻¹-N) still greatly outperformed the scenario A (2589.0 kWh kg⁻¹-N), demonstrating that the approach from Scenario B can mitigate the intrinsic critical limitations of directly utilizing dilute nitrate streams (FIG. 9E), and provide a new strategy for nitrate valorization going forward.

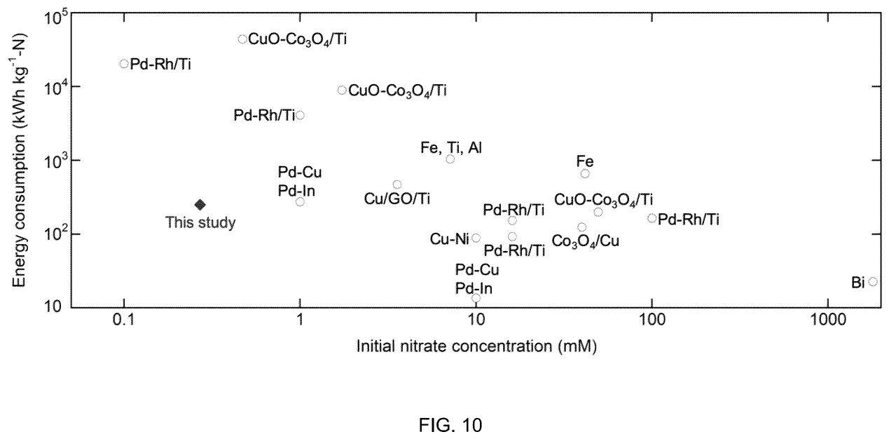

A comparative analysis of the specific energy consumption (kWh kg⁻¹-N) in this work with reported studies on electrochemical nitrate reduction (FIG. 10) was investigated. The starting nitrate concentration was shown to be negatively correlated with specific energy consumption, due to limitation in mass transfer and side reactions. Compared to other electrocatalytic systems that treat similar concentrations of starting nitrate (0.1-3.5 mM NO₃⁻ with a specific energy consumption of 275-44,000 kWh kg⁻¹-N), this study shows a significant reduction in energy consumption (251.3 kWh kg⁻¹-N starting at 0.27 mM), providing an energy-efficient way for treating nitrate (FIG. 10).

In summary, bifunctional electrodes comprising a redox-active polymer to function as an electrosorbent and a metal oxide electrocatalyst have been shown to enable the energy-efficient reactive separation of dilute nitrate waste streams and valorization into value-added ammonium. Exemplary bifunctional electrodes displayed selectivity for nitrate by utilizing both hydrogen bonding and ion exchange, with the underlying mechanisms elucidated through both electrosorption experiments and electronic structure calculations. Demonstrating remarkable reversibility and catalytic activity, the composite allowed potential-controlled tuning of nitrogen speciation (˜100% nitrate recovery at −0.5 V vs Ag/AgCl or >80% conversion to ammonium at −1.4V vs Ag/AgCl), in addition to providing modular electrochemically-mediated up-concentration. An exemplary PANI-Co₃O₄/CNT composite was applied for the combined reactive separation of dilute nitrate from a practical agricultural tile drainage, which demonstrated 24- and 10-fold increase in ammonia production rate (108.1 ug h⁻¹ cm⁻²) and energy efficiency (251.3 kWh kg⁻¹-N) as compared to reaction only (4.5 ug h⁻¹ cm⁻² and 2589.0 kWh kg⁻¹-N), outperforming other electrocatalytic systems that have been evaluated at similarly low nitrate concentrations. From a nitrate remediation perspective, this study provides a highly efficient, chemical-free option which couples the benefit of ammonia generation. From an ammonia synthesis/waste valorization perspective, this approach enables the direct utilization of dilute nitrate as a feedstock for decentralized ammonia production, potentially mitigating the need for carbon-intensive Haber-Bosch process, and establishing new integrated pathways for chemical feedstock or energy carrier production. Fundamentally, this work highlights the central importance of integration of reaction and separations in electrochemical conversion, and provide a generalized strategy for reactive separation of dilute molecules through overcoming intrinsic transport limitations by selective electrosorption.

### Methods

Preparation of PANI-Co₃O₄/CNT Electrodes

As a substrate, a titanium (Ti) mesh (Fuel Cell Store, thickness: 2 inch, strand width: 0.004 inch, percent open area: 62%) was cut into a 1.5 cm×2 cm. 18 mg carbon nanotubes (multiwalled carbon nanotubes, Sigma-Aldrich) were dispersed in 3 mL of N,N-dimethylformamide (DMF) by sonicating for 3 h in icy water. The titanium meshes were coated with the CNT slurry by dip-coating, and an average CNT loading of 1.5 mg cm⁻² was achieved. The fabrication route of PANI-Co₃O₄/CNT is shown in FIG. 4. Co₃O₄/CNT electrodes were prepared by Co(OH)₂ electrodeposition followed by heat treatment. The electrodeposition was performed in 0.1 M Co(NO₃)₂·6H₂O at a fixed potential of −1.0 V vs Ag/AgCl using CNT-coated Ti as a working electrode. Unless otherwise stated, electrodeposition lasted for 4 min. Thus-obtained electrodes (Co(OH)₂/CNT) were rinsed with deionized water, and dried in an oven at 100° C. The Co(OH)₂/CNT electrodes were subsequently heated at 200° C. for 1 h with a heating rate of 3° C. min⁻¹ to obtain Co₃O₄/CNT. The electropolymerization of PANI was performed under galvanostatic conditions in 0.2 M aniline+0.5 M H₂SO₄, using as-prepared Co₃O₄/CNT as an anode. Unless otherwise indicated, electrodeposition was carried out at 3 mA cm⁻² for 5 min. After the electropolymerization, the obtained electrodes were washed with deionized water. The active area of the electrode was 1.5 cm². For PANI/CNT and Co₃O₄/CNT, we utilized a simple gravimetric method to determine the mass difference between before and after electrodeposition of PANI or Co₃O₄. For PANI-Co₃O₄/CNT composites, a gravimetric method was used to measure the sum of the mass of PANI and Co₃O₄. Following digestion, inductively coupled plasma optical emission spectrometry (ICP-OES) analysis was used to estimate the cobalt content, from which PANI content was determined.

### Electrochemical Testing

Electrochemical tests were conducted with a potentio/galvanostat (Squidstat Solo, Admiral Instrument). Electrosorption of nitrate was conducted in a BASi (Bioanalytical Systems, Inc.) VC-2 voltammetry electrochemical cell with a PANI/CNT or PANI-Co₃O₄/CNT working electrode, a platinum wire (length: 7.5 cm, diameter: 0.5 mm, purity: 99.99%) as a counter electrode, and Ag/AgCl (3 M NaCl) as a reference electrode. An electrolyte containing 3 mL of 5 mM NO₃⁻ and 5 mM Cl⁻ was used, with the pH of the solution being controlled with HCl or NaOH. The potentiostatic electrosorption was performed to evaluate the performance of PANI electrosorbent at various oxidation states, at 0, +0.2, +0.4, +0.6, and +0.8 V vs Ag/AgCl. Unless otherwise specified, electrosorption was performed for 30 min. The cell resistance of the adsorption cell was found to be 193±5 0.

PANI-Co₃O₄/CNT were regenerated in either BASi VC-2 cells (31±1Ω,) or a H-type cell (24±1Ω) using the Nafion 117 membrane (DuPont). When using the VC-2 cells for regeneration, the counter electrode was isolated from the working electrolyte by the use of a glass body and porous CoralPor™ tip to avoid oxidation of produced ammonium. To prepare Nafion 117 for H-type cell tests, Nafion sheets were cut and boiled in 3% hydrogen peroxide for 1 h, rinsed in deionized water, boiled for 2 h in deionized water to remove residual peroxide, treated in 0.5 M H₂SO₄ for 1 h, and then rinsed and stored in deionized water. Nitrate-adsorbing electrodes were transferred to a desorption electrolyte of 0.1 M NaCl, and the release (desorption) of nitrate and coupled electrocatalysis were assessed at the following applied potentials: −0.5, −0.7, −0.9, −1.1, −1.3, and −1.4V vs Ag/AgCl. Unless otherwise noted, electrochemical reductions were conducted for 1 h. For all the electrochemical tests, the potential was not IR-compensated.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A redox-active composite comprising:
a conductive substrate including electrosorbent regions and electrocatalytic regions thereon,
wherein the electrosorbent regions comprise a redox-active polymer, and
wherein the electrocatalytic regions comprise a metal oxide.

2. The redox-active composite of claim 1, wherein the electrosorbent regions are spatially distinct from the electrocatalytic regions.

3. The redox-active composite of claim 1, wherein the redox-active polymer includes an amine functional group, and/or
wherein the redox-active polymer is configured for ion-exchange or hydrogen bonding with nitrate.

4. The redox-active composite of claim 1, wherein the redox-active polymer comprises polyaniline and/or polypyrrole.

5. The redox-active composite of claim 1, wherein the metal oxide is stable under anodic and cathodic polarization, and/or
wherein the metal oxide is stable in acidic and alkaline solutions.

6. The redox-active composite of claim 1, wherein the metal oxide comprises cobalt oxide.

7. The redox-active composite of claim 1, wherein the conductive substrate comprises a metal support coated with a carbon-based material.

8. The redox-active composite of claim 7, wherein an average loading level of the carbon-based material on the metal support is in a range from about 0.5 mg cm⁻² to about 4 mg cm⁻².

9. The redox-active composite of claim 1, wherein a mass loading of the metal oxide on the conductive substrate is in a range from about 0.3 mg to about 5 mg, and/or
wherein a mass loading of the redox-active polymer on the conductive substrate is in a range from about 1 mg to about 5 mg.

10. A bifunctional electrode for electrochemical reactive separation of nitrate to ammonia comprising the redox-active composite of claim 1.

11. An electrochemical cell for electrochemical reactive separation of nitrate to ammonia, the electrochemical cell comprising:
a vessel configured for flow of a fluid therethrough;
a bifunctional electrode comprising the redox-active composite of claim 1 positioned in the vessel; and
a counter electrode spaced apart from the bifunctional electrode in the vessel.

12. An electrochemical method for nitrate remediation and ammonium production, the electrochemical method comprising:
providing an electrochemical cell including a working electrode comprising a conductive substrate having electrosorbent regions and electrocatalytic regions thereon;
applying an anodic potential to the working electrode and flowing a waste fluid into the electrochemical cell, whereby nitrate from the waste fluid is selectively adsorbed onto the electrosorbent regions and a purified water stream is formed;
removing the purified water stream from the electrochemical cell;
applying a first cathodic potential to the working electrode and flowing a receiving fluid into the electrochemical cell, whereby the nitrate is released from the electrosorbent regions into the receiving fluid and a concentrated receiving solution is formed;
applying a second cathodic potential to the working electrode, the second cathodic potential being more negative than the first cathodic potential, whereby the nitrate from the concentrated receiving solution is electrocatalyzed to ammonium or ammonia and the electrosorbent regions on the conductive substrate are regenerated.

13. The electrochemical method of claim 12, wherein the waste fluid is obtained from industrial runoff, agricultural runoff, polluted groundwater, or another source.

14. The electrochemical method of claim 12, wherein the waste fluid includes a dilute concentration of the nitrate, the dilute concentration being less than 10 mM.

15. The electrochemical method of claim 14, wherein a concentration of the nitrate in the concentrated receiving solution is at least 8 times the dilute concentration of the nitrate in the waste fluid.

16. The electrochemical method of claim 12, wherein an ammonia yield rate of the working electrode is at least about 100 μg h⁻¹ cm⁻².

17. The electrochemical method of claim 12 being carried out with a total energy consumption of less than 300 kWh kg⁻¹-N.

18. The electrochemical method of claim 12, wherein the electrosorbent regions comprise a redox-active polymer and the electrocatalytic regions comprise a metal oxide, and
wherein the electrosorbent regions are spatially distinct from the electrocatalytic regions.

19. The electrochemical method of claim 12, wherein the conductive substrate comprises a metal support coated with a carbon-based material.

20. A method of making a bifunctional electrode, the method comprising:
electrodepositing a metal hydroxide on a conductive substrate, the metal hydroxide accumulating during electrodeposition to form clusters;
after the electrodeposition, heat treating the clusters to transform the metal hydroxide into a metal oxide, thereby forming electrocatalytic regions comprising the metal oxide on the conductive substrate;
after the heat treatment, electropolymerizing a redox-active polymer on the conductive substrate, the electropolymerization occurring in regions between the electrocatalytic regions, thereby forming electrosorbent regions comprising the redox-active polymer on the conductive substrate.
